(19) United States
(12) Patent Application Publication
(10) Pub. No.: US 2005/0190205 A1
(43) Pub. Date: Sep. 1, 2005

(54) Color correction circuit and image display apparatus having same

(75) Inventor: Fumio Koyama, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/064,019

(22) Filed: Feb. 23, 2005

(30) Foreign Application Priority Data
Mar. 1, 2004 (JP) 2004-055873

(51) Int. Cl. G09G 3/36

(52) U.S. Cl. 345/690

(57) ABSTRACT

Aspects of the invention can reduce the memory capacity constituting a lookup table while reducing the lower in color correction accuracy. A color correction circuit for correcting for color of an image to be displayed, in an image display apparatus, can include a two-dimensional lookup table. A color correction circuit section is for correcting for intensity level of at least one signal of three signals of a light-intensity signal, a first chrominance signal and a second chrominance signal that are to be inputted as an image signal representative of the image, by use of a correcting value stored in the two-dimensional lookup table, according to a combination in intensity level of the first and second chrominance signals. The two-dimensional lookup table can store, as the correcting value, correcting values corresponding respectively to combinations to be specified by an intensity level of the first chrominance signal and an intensity level of the second chrominance signal.

### BACKGROUND

Aspects of the invention relate to image display apparatus, such as liquid-crystal projectors, and more particularly to an art for correcting for color in a display image.

A related art liquid-crystal projector, one of image display apparatuses, in a three-plate type, for example, has three liquid-crystal panels serving as display devices corresponding respectively to R (red), G (green) and B (blue). In such a liquid-crystal projector, the illumination light emitted from the illumination system is separated into R, G and B colors of light which are then incident respectively upon the liquid-crystal panels for the corresponding colors. By inputting R, G and B signals, as image signals, respectively, to the liquid-crystal panels for corresponding colors, the liquid-crystal panels are driven according to the signals, thus allowing the colors of incident light to transmit through the same. The R, G and B of transmission light (color light) obtained from the three liquid-crystal panels, after being mixed, are projected to a screen by the projection system, whereby a color image is displayed on the screen according to the R, G and B signals.

The liquid-crystal panel used on such a liquid-crystal projector has a property that the wavelength characteristic of transmission light changes with changing intensity level of the input signal.

For example, in the related art liquid-crystal panel for R, when there is an intensity level change in the R signal inputted, the R-color light transmitted the liquid-crystal panel is changed in its wavelength characteristic correspondingly, resulting in an approximation of the R transmission light color toward magenta or orange color. Namely, the chroma coordinate of the R transmission light, normally not allowed for change with an intensity level change in R signal, is changed by a change of intensity level. This can be true for the case where there is an intensity level change in input G and B signals on the liquid-crystal panels for G and B.

As described above, where there is a change in chroma-coordinate of R, G and B transmission light due to an in intensity level change in the R, G and B signals, correct color reproduction of an image can be difficult to effect according to the R, G and B signals. Consequently, it is considered that, in order to correctly reproduce an image color according to R, G and B signals, the exiting color light from a display device is corrected for according to an intensity level change of the R, G and B signals by use of a color correction circuit based on a three-dimensional lookup table (hereinafter, referred also to as a “3D-LUT”), see, for example, JP-A-2002-41016, JP-A-2002-140060, JP-A-2002-344761 and JP-A-2003-271122.

### SUMMARY OF THE INVENTION

Here, the R, G and B signals are usually expressed with intensity-level data having 8 bits or greater, i.e., intensity level values equal to or greater than 256 levels. Accordingly, in order to correct for colors of a light emitted from the display device according to an intensity level change of the R, G and B signals, there is a need for the 3D-LUT to store correcting values in the number equal to or greater than (256×256×256) corresponding to all the combinations of RGB signal intensity levels. Consequently, memory capacity is required extremely great in constituting a color correction circuit with a 3D-LUT, resulting in a quite great scale of circuit structure in the present circuit technology.

For this reason, when actually constituting a 3D-LUT, it is a practice to provide a structure for storing the correcting values corresponding respectively, to the combinations of rough intensity levels the respective intensity levels of R, G and B signals are divided at suitable intervals, e.g., the combinations of the higher 3-4 bits of R, G and B signal intensity levels, instead of all the combinations of inputted R, G and B signal intensity levels, thereby reducing the memory capacity needed.

However, as the memory capacity constituting the 3D-LUT is made smaller, there is a need to increase the interval for dividing the R, G and B signal intensity levels. This, accordingly, can decrease the number of correcting values to be specified by the combinations of R, G and B signal intensity levels, i.e., correcting values to be stored in the 3D-LUT, resulting in a difficulty in precise correction of color. As a result, there can be a problem of lowered accuracy in color correction.

An aspect of the invention can provide an art capable of reducing the memory capacity constituting a lookup table while suppressing against the lower in color correction accuracy.

An exemplary color correction circuit of the invention is a color correction circuit for correcting for color of an image to be displayed in an image display apparatus. The color correction circuit can include a two-dimensional lookup table, and a color correction circuit section for correcting for intensity level of at least one signal of three signals of a light-intensity signal, a first chrominance signal and a second chrominance signal that are to be inputted as an image signal representative of the image, by use of a correcting value stored in the two-dimensional lookup table, according to a combination in intensity level of the first and second chrominance signals. The two-dimensional lookup table can store, as the correcting value, correcting values corresponding respectively to combinations to be specified by an intensity level of the first chrominance signal and an intensity level of the second chrominance signal.

The color correction circuit of the invention can be configured by a two-dimensional lookup table using three signals of intensity-level signal, first chrominance signal and second chrominance signal instead of the three signals of red, green and blue signals as in the related art and for storing correcting values corresponding respectively to the combinations to be specified by the intensity levels of the first and second chrominance signals excepting, of the three signals, the intensity-level signal having no bearing on color change. The number of combinations for specifying the correction values in the two-dimensional lookup table is a reciprocal of the number of intensity levels in one signal relative to the number of combinations to be specified by the intensity levels of red, green and blue signals as in the related art three-dimensional lookup table provided that the number of intensity levels is equal between the signals. Accordingly, it is possible to reduce the memory capacity constituting the lookup table.

Due to this, the color correction circuit of the invention can reduce the memory capacity required in constituting a lookup table while suppressing against the lower in color correction accuracy.

In the color correction circuit of the invention, preferably the two-dimensional lookup table stores, as the correcting value, an intensity-level signal correcting value, a first chrominance signal correcting value and a second chrominance signal correcting value that correspond respectively to the intensity-level signal, the first chrominance signal and the second chrominance signal. This can correct for the respective intensity levels of three signals of the intensity-level, first chrominance and second chrominance signals in accordance with a combination specified by the intensity levels of the first and second chrominance signals.

Incidentally, in the color correction circuit, the intensity-level signal correcting value, the first chrominance signal correcting value and the second chrominance signal correcting value may be a light-intensity signal offset value, a first chrominance signal offset value and a second chrominance offset value that are to be respectively added to the intensity-level signal, the first chrominance signal and the second chrominance signal, the color correction circuit section having three addition circuits for adding the light-intensity signal offset value, the first chrominance signal offset value and the second chrominance signal offset value respectively to corresponding ones of the intensity-level signal, the first chrominance signal and the second chrominance signal.

In this manner, in case the intensity-level signal correcting value, the first chrominance signal correcting value and the second chrominance signal correcting value are given a light-intensity signal offset value, a first chrominance signal offset value and a second chrominance signal offset value to be respectively added to the intensity-level signal, the first chrominance signal and the second chrominance signal, then the memory capacity can be further reduced which is required in constituting the two-dimensional lookup table.

Meanwhile, in the color correction circuit, preferably two-dimensional lookup table stores, as the correcting value, a first chrominance signal correcting value and a second chrominance signal correcting value that correspond respectively to the first chrominance signal and the second chrominance signal. This can correct for the respective intensity level of the first and second chrominance signals in accordance with a combination specified by the intensity levels of the first and second chrominance signals.

Incidentally, in the color correction circuit, preferably the first chrominance signal correcting value and the second chrominance signal correcting value are a first chrominance signal offset value and a second chrominance signal offset value that are to be respectively added to the first chrominance signal and the second chrominance signal, the color correction circuit section having two addition circuits for adding the first chrominance signal offset value and the second chrominance signal offset value respectively to corresponding ones of the first chrominance signal and the second chrominance signal.

In this manner, in case the first and second chrominance signal correcting values are given first and second chrominance signal offset values to be added respectively to the first and second chrominance signals, the memory capacity can be further reduced which is required in constituting the two-dimensional lookup table. Meanwhile, in the color correction circuit, preferably the two-dimensional lookup table stores, as the correcting value, a light-intensity signal correcting value corresponding to the light-intensity signal. This can correct for intensity level of the intensity-level signal in accordance with a combination specified by the intensity levels of the first and second chrominance signals.

Incidentally, in the color correction circuit, preferably the intensity-level signal correcting value may be a light-intensity signal offset value to be added to the intensity-level signal, the color correction circuit section adding the intensity-level signal offset value to a corresponding one of the intensity-level signal. In this manner, in case the intensity-level signal correcting value is given an intensity-level signal offset value to be added to the intensity-level signal, the memory capacity can be further reduced which is required in constituting the two-dimensional lookup table.

In the color correction circuit, preferably, a first color converting circuit section can be provided for converting the light-intensity signal, the first chrominance signal and the second chrominance signal after corrected in the color correction circuit section into a red signal corresponding to red, a green signal corresponding to green and a blue signal corresponding to blue. In this manner, the color correction circuit of the invention can output the intensity-level signal, first chrominance signal and second chrominance signal after corrected in the color correction circuit section by conversion into a red signal corresponding to red, green signal corresponding to green and blue signal corresponding to blue. This is convenient where the signal to be inputted to the display device constituting the image display apparatus is of red, green and blue signals, for example.

Meanwhile, in the color correction circuit, preferably a second converting circuit section can be provided for converting a red signal, a green signal and a blue signal that are inputted as an image signal representative of the image into the light-intensity signal, the first chrominance signal and the second chrominance signal that are to be inputted to the color correction circuit section. In this manner, the color correction circuit of the invention can convert the red, green and blue signals inputted as an image signal into the intensity-level signal, first chrominance signal and second chrominance signal to be inputted to the color correction circuit section. This is convenient where red, green and blue signals are to be inputted as an image signal, for example.

Incidentally, the invention is not limited to the above color correction circuit form but can realize a form as an image display apparatus provided with the same.

### BRIEF DESCRIPTION OF THE DRAWINGS

The invention will be described with reference to the accompanying drawings, wherein like numerals reference like elements, and wherein:

FIG. 1a is an exemplary block diagram showing a schematic configuration of a liquid-crystal projector to which the color correction circuit of the invention is applied;

FIG. 2 is an exemplary block diagram showing the color correction circuit;

FIG. 3 is an exemplary explanatory view showing a modification to a color correction circuit section; and

FIG. 4 is an exemplary explanatory view showing another modification to the color correction circuit section.

### DETAILED DESCRIPTION OF EMBODIMENTS

Hereunder, an exemplary embodiment of the invention will be explained on the basis of an example, in the following order.
A. Liquid-crystal Projector Schematic Construction
B. Color Correction Circuit
C. Modifications
   A. Liquid-Crystal Projector Schematic Configuration

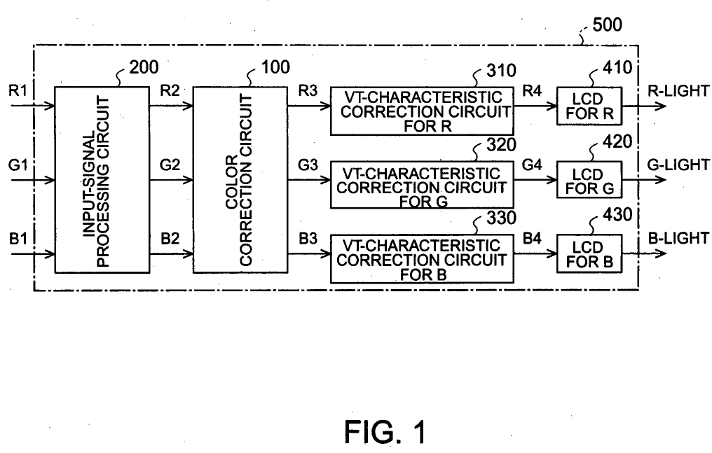

FIG. 1 is an exemplary block diagram showing a schematic configuration of a liquid-crystal projector to which is applied a color correction circuit as a first exemplary embodiment of the invention. A liquid-crystal projector 500, shown in FIG. 1, is so-called a three-plated type having three liquid crystal panels (hereinafter, referred also to as “LCDs”) 410-430 as display devices corresponding respectively to R (red), G (green) and B (blue). Besides, the liquid-crystal projector 500 can include an input-signal processing circuit 200, a color correction circuit 100 according to the invention, and V-T characteristic correction circuits 310-330 for R, G and B.

Inputted externally R, G and B signals R1, G1 and B1 as image signals, the input-signal processing circuit 200 can perform an analog/digital conversion when those signals are analog signals, and a frame-rate conversion and resize processing in accordance with the forms of these signals. Otherwise, when making a menu display, it acts to superimpose menu screens, or so. Incidentally, where the image signal inputted is a composite signal, the composite signal can be processed together with a processing of demodulation and separation into R, G and B and synchronization signals, or so.

Then, the color correction circuit 100 makes a correction on the digital R, G and B signals R2, G2, B3 outputted from the input-signal processing circuit 200, thereby making a correction for color of the transmission light (color light) obtained through mixing by projection from the liquid-crystal panels 410-430. Subsequently, the VT-characteristic correction circuits 310-330 for R, G and B each make a y-correction, on the R, G or B signal R3, G3, B3 outputted from the color correction circuit 100, taking account of the VT characteristic (voltage-transmissivity characteristic) of the R, G or B liquid-crystal panel 410-430. Note that the VT-characteristic correction circuits 310-330 for R, G and B are usually configured by one-dimensional lookup tables (hereinafter, referred also to as 1D-LUTs).

Meanwhile, the R, G and B liquid-crystal panels 410-430 input therein the R, G and B signals R4, G4, B4 outputted from the VT-characteristic correction circuits 310-330, to project R, G and B of transmission light (color light) based on these signals. Specifically, the illumination light exited an illumination system (not shown) can be separated into R, G and B of color light which are then incident respectively upon the corresponding colors of liquid-crystal panels 410-430. At the same time, the R, G and B signals R4, G4, B4 from the VT-characteristic correction circuits 310-330 are also inputted respectively to the corresponding colors of liquid-crystal panels 410-430. According to the color signals inputted, the liquid crystal panels are driven to pass the incident color light.

In this manner, the R, G and B of transmission light (color light) exited the R, G and B liquid-crystal panels 410-430 are mixed together and then projected by a projection system onto a screen (not shown). Thus, a color image is displayed on the screen, in accordance with R, G and B signals.

B. Color Correction Circuit

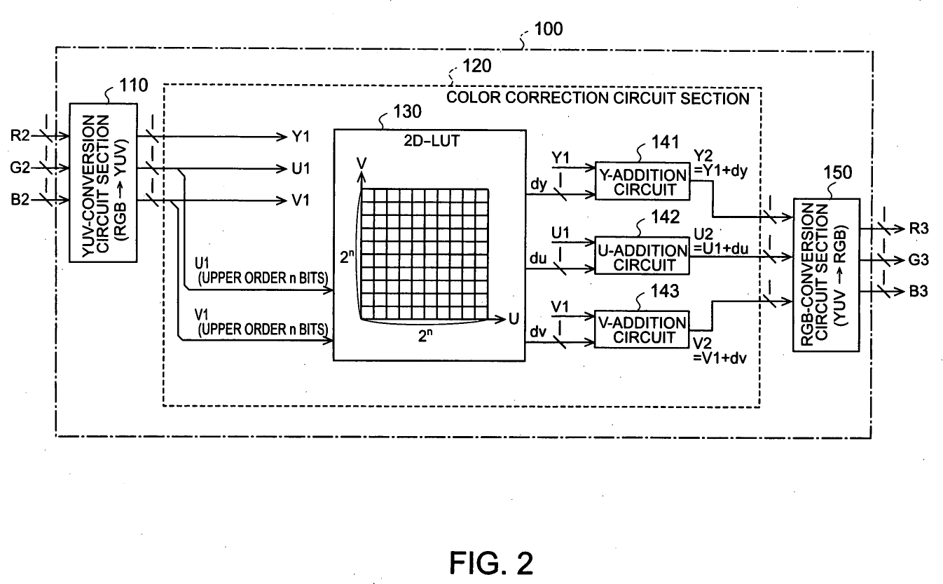

FIG. 2 is an exemplary block diagram showing in detail the color correction circuit 100. The color correction circuit 100 has a YUV-conversion circuit section 110, a color correction circuit section 120 and an RGB-conversion circuit section 150, as shown in FIG. 2.

The YUV-conversion circuit section 110 can be configured by a general matrix circuit for converting the R, G and B signals into a light-intensity signal (Y signal) representative of a light intensity (Y), a first chrominance signal (U signal) representative of a chrominance (U) of subtracting the Y signal from the B signal, and a second chrominance signal (V signal) representative of a chrominance (V) of subtracting the Y signal from the R signal. The YUV conversion circuit section 110 converts 1 bits (1 is an integer equal to or greater than 2) of inputted R, G and B signals R1, G1, B1 into 1 bits of Y, U and V signals Y1, U1, V1. Incidentally, the R, G and B signals are generally of the number of bits 1≧8.

The color correction circuit section 120 has a two-dimensional lookup table (hereinafter, referred also to as “2D-LUT”) 130 and Y, U and V addition circuits 141-143. The 2D-LUT 130 is a memory circuit for storing an 1-bit Y-signal offset value dy as a Y signal correcting value, an 1-bit U-signal offset value du as a U signal correcting value and an 1-bit V-signal offset value dv as a V signal correcting value, as correcting values corresponding respectively to the combinations of the higher order n bits (n is an integer equal to or greater than 1 and equal to or smaller than 1) of the U signal and the higher order n bits of the V signal. Meanwhile, the 2D-LUT 130 is a memory circuit for outputting a (3×1)-bit correcting value in response to a combination in intensity level of U and V signals U1, V1 inputted. Incidentally, such a memory circuit is to be realized by use of a RAM having an (n+n)-bit address wherein the (n+n)-bit addresses are assigned to the higher n bits of U signal and the higher n bits of V signal in the order of higher bit while a (3×1)-bit output is assigned to an output of Y-signal correcting value (Y signal offset value dy), U-signal correcting value (U signal offset value du) and V-signal correcting value (V signal offset value dv), at an interval of 1 starting from the highest ordered bit. Incidentally, the offset value dy, du, dv can take a positive or negative value. Meanwhile, because the offset value is usually an extremely small value, output may be with an offset value smaller in bits than 1 bits.

The Y, U and V addition circuits 141-143 adds the offset values dy, du, dv respectively outputted from the 2D-LUT 130, respectively, to the corresponding Y, U and V signals Y1, U1, V1, to generate post-correction Y, U and V signals Y2, U2 and V2. As in the above, the color correction circuit section 120 corrects the Y, U and V signals Y1, U1, V1 outputted from the YUV-conversion circuit section 110 in accordance with the combination in intensity level of U and V signals U1, V1, to thereby output post-correction Y, U and V signals Y2, U2 and V2.

The RGB-conversion circuit section 150 can be configured by a general matrix circuit for converting the Y, U and V signals into R, G and B signals. The RGB-conversion circuit section 150 can restore the Y, U and V signals Y2, U2 and V2 outputted from the color correction circuit section 120 into R, G and B signals R3, G3, B3.

As explained above, the color correction circuit 100 makes a correction on the R, G and B signals R2, G2, B2 outputted from the input-signal processing circuit 200, to correct for color of the transmission light (color light) obtained through mixing by projection from the liquid-crystal panels 410-430. Here, the color correction circuit 100 is characterized in that the lookup table constituting the color correction circuit section 120 uses the 2D-LUT 130 instead of a 3D-LUT as in the related art. Meanwhile, the 2D-LUT 130 is characterized in its configuration to store correcting values corresponding respectively to the combinations in intensity level of U-and-V two chrominance signals of the Y, U and V signals.

Of the Y, U and V signals, the Y signal is a light-intensity signal which is a signal representative of so-called lightness. The U signal is a first chrominance signal (B−Y signal) the Y signal is subtracted from the B signal, which is a signal representative of so called blueness. The V signal is a second chrominance signal (R−Y signal) the Y signal is subtracted from the R signal, which is a signal representative of so called redness. Consequently, it can be considered that, although the intensity-level change of the U signal and V signal has a comparatively great effect upon the color change in a transmission light exited the liquid-crystal panel 410-430, the intensity-level change of the Y signal has a comparatively small effect upon the color change in a transmission light exited the liquid-crystal panel 410-430. Accordingly, the intensity-level change in a Y signal is to be thought having no effect upon the color change in a transmission light exited the liquid-crystal panel 410-430.

Consequently, the color correction circuit 100 of the exemplary embodiment is configured employing the 2D-LUT 300 instead of a 3D-LUT as in the related art, as a lookup table constituting the color correction circuit section 120. This can obtain an effect as explained in the below.

For example, in the related art 3D-LUT having such a configuration as to store correcting values corresponding respectively to the combinations in intensity level of R, G and B signals (hereinafter, merely referred to as “RGB-type 3D-LUT”), in case the number of higher order bits p in the input R, G and B signals to the 3D-LUT be assumed p=4, the R, G and B signals have the number of intensity-level combinations Krgb given as:
Krgb=2⁴×2⁴×2⁴=16³=4096.

Meanwhile, in the 2D-LUT 130 of the exemplary embodiment, provided that the number of higher order bits n in the input U signal and V signal are assumed n=4 that is equal to the higher order bits p in the R, G and B signals, the U and V signals have the number of intensity-level combinations Kyuv given as:
Kyuv=2⁴×2⁴=16²=256.

Thus, the number of intensity-level combinations Kyuv of the U and V signals can be given one-sixteenth ( 1/16), in magnitude, of the number of intensity-level combinations Krgb of the R, G and B signals, i.e., a reciprocal of the number of intensity levels in one of the R, G and B signals.

Accordingly, by providing the lookup table constituting the color correction circuit section 120 as a 2D-LUT (hereinafter, merely referred also to as a “YUV-type 2D-LUT”) for storing the correcting values corresponding, respectively, to the intensity-level combinations of the U and V signals of among the Y, U and V signals to be inputted to the color correction circuit section 120, the memory capacity for configuring the lookup table can be reduced as compared to the conventional RGB-type 3D-LUT. Meanwhile, because the number of intensity levels of U and V signals having a greater effect upon color change can be given equal to the number of intensity levels of the R, G and B signals for input to the related art RGB-type 3D-LUT, the accuracy of color correction can be suppressed from lowering.

Conversely, in case the number of intensity-level combinations Kyuv of U and V signals are assumably permitted up to the equal magnitude to the number of intensity-level combinations Krgb of R, G and B signals in the RGB-type 3D-LUT, it is possible to increase the number of intensity-level combinations Kyuv of U and V signals. Accordingly, the number of higher order bits of the U and V signals to be inputted to the 2D-LUT 130 can be increased greater than the number of bits of the R, G and B signals for input to the RGB-signal-type 3D-LUT.

For example, in case the U and V signals have the number of higher order bits n that is assumed n=6, the number of intensity-level combinations Kyuv of Y, U and V signals is given as:
Kyuv=2×2=64²=4096.

Thus, this is equal in magnitude to the number of combinations Krgb where the R, G and B signals inputted are given the number of higher order bits p as p=4 in the RGB-type 3D-LUT.

Accordingly, by providing the 2D-LUT 130 in the exemplary embodiment as a YUV-type 2D-LUT, the number of higher order bits of the U and V signals for input to the YUV-type 2D-LUT can be increased greater than the number of higher order bits of the R, G and B signals for input to the RGB-type 3D-LUT while keeping the capacity of the memory constituting the lookup table equal to that of the RGB-type 3D-LUT. As a result of this, the color correction circuit configured by a color correction circuit section using the 2D-LUT 130 of the exemplary embodiment can be increased in color correction accuracy as compared to the color correction circuit using the conventional RGB-type 3D-LUT.

C. Modifications

It should be understood that the invention is not limited to the above example and embodiment, but can be practiced in various forms within the spirit and scope of the invention.

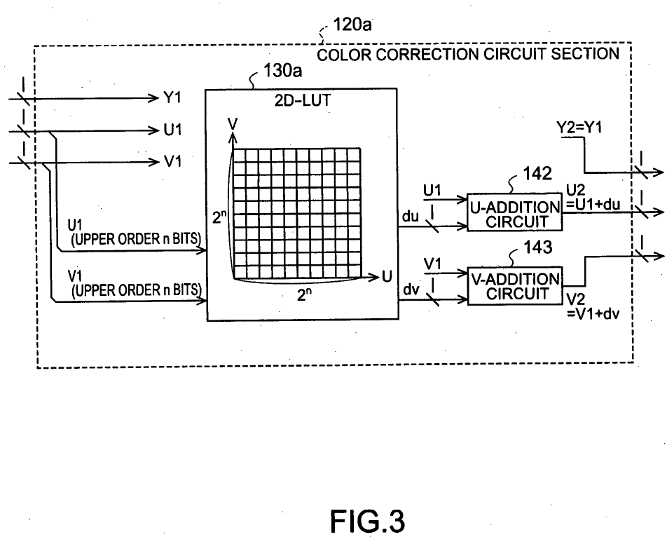

FIG. 3 is an explanatory view showing a modification to the color correction circuit section. The color correction circuit section 120a can include a 2D-LUT 130a and addition circuits 142, 143 for U and V.

The 2D-LUT 130a can be the same in storing the correcting values corresponding respectively to the combinations of the higher order n bits of U signal and the higher order n bits of V signal, similarly to the 2D-LUT 130 in the exemplary embodiment. However, it is different in storing, as correcting values, a U-signal offset value du as a U-signal correcting value and a V-signal offset value dv as a V-signal correcting value excepting for a Y-signal offset value dy as a Y-signal correcting value.

Where using a 2D-LUT 130a as a lookup table as in the color correction circuit section 120a in the modification, the memory capacity can be further reduced in an amount not storing the Y-signal offset value dy as an intensity-signal correcting value as compared to the 2D-LUT 130 of the exemplary embodiment.

Incidentally, in the case of a color correction circuit using the color correction converting circuit section 120a of the modification, correction is impossible for Y-signal intensity level. However, because there is considered no effect of the intensity-level change in the Y signal upon a color change in the transmission light exiting the liquid-crystal panel 410-430, it is possible to obtain the similar effect to that of the color correction circuit 120 of the exemplary embodiment even with the color correction circuit using the color-correction converting circuit 120a of the modification.

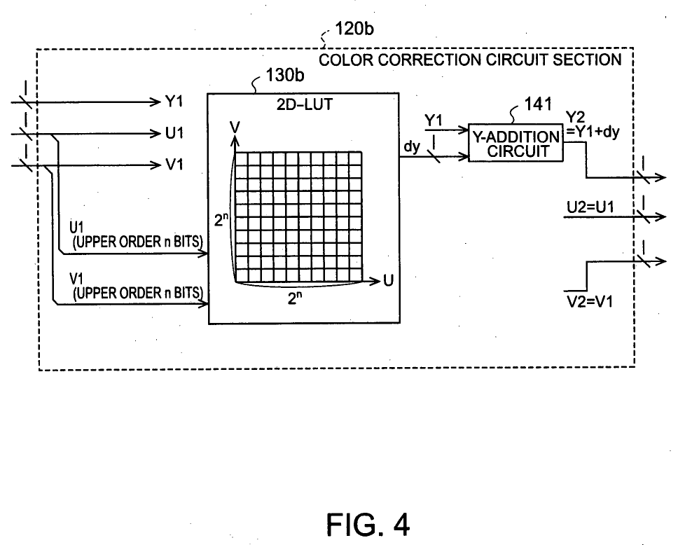

FIG. 4 is an explanatory view showing another modification to the color correction circuit section. The color correction circuit section 120b has a 2D-LUT 130b and an addition circuit 141 for Y.

The 2D-LUT 130b is the same in storing the correcting values corresponding respective to the combinations of the higher order n bits of U signal and the higher order n bits of V signal similarly to the 2D-LUT 130 in the exemplary embodiment, but different in storing, as a correcting value, only a Y-signal offset value dy as a light-intensity-signal correcting value.

Where the 2D-LUT 130b is employed as a lookup table as in the color correction circuit section 120b of the modification, memory capacity can be reduced in an amount not storing a U-signal offset value du as a U-signal correcting value and V-signal offset value dv as a V-signal correcting value, as compared to the 2D-LUT 130 of the embodiment and 2D-LUT 130a of the modification.

Incidentally, in the case with the color correction circuit using the color correction conversion circuit section 120b of the modification, the U and V signals are not corrected for intensity level thus making it impossible to make a color correction as in the color correction circuit 120 of the exemplary embodiment. However, it is known that color impression can be changed by correcting the intensity level in the Y signal. For example, lowering the intensity level provides an impression as if the color were deepened while raising the intensity level gives an impression as if the color were shallowed. Accordingly, it is effective in correcting for color of a display image to configure a color correction circuit by means of a color correction conversion circuit section 120b using a 2D-LUT 130b as a lookup table.

In the above exemplary embodiment, the 2D-LUT 130 explained on the example of the configuration to store, as correcting values in accordance with a combination of U and V signal intensity levels, a Y-signal offset value dy as a Y-signal correcting value and a U-signal offset value du as a U-signal correcting value and V-signal offset value dv as a V-signal correcting value. However, it should be understood that this is not limitative, but that the configuration may be to store the correcting values corresponding to the signals Y2, U2, V2 outputted from the addition circuits 141-143 of the color-correction circuit section 120 of the exemplary embodiment. This configuration does not require the addition circuits 141-143. However, because the offset values dy, du, dv are generally values smaller than the intensity level values of Y, U and V signals Y2, U2, V2, the configuration for storing the offset values dy, du, dv as in the exemplary embodiment can be reduced in memory capacity configuring the 2D-LUT than the configuration for storing correcting values leaching the Y, U and V signals Y2, U2, V2.

Meanwhile, this is true for the 2D-LUT 130a, 130b of the modification.

The above exemplary embodiment explained the configuration that the color correction circuit 100 has the YUV-conversion circuit section 110 for converting R, G and B signals into Y, U and V signals and the RGB-conversion circuit section 150 for converting Y, U and V signals into R, G and B signals. However, it should be understood that this is not limited. For example, where the image signal to be inputted to the liquid-crystal projector 500 is in a Y, U and V signal form, there is not necessarily a need to provide a YUV-conversion circuit section 110 in case the image signals to be outputted from the input-signal processing circuit 200 are Y, U and V signals. Meanwhile, the R, G and B liquid-crystal panels 410-430 are configured to input Y, U and V signals, there is not necessarily a need of providing an RGB-conversion circuit section 150.

In the above exemplary embodiment, explanation was made on the example of configuration that the color correction circuit 120, at the 2D-LUT 130, determines the correcting values corresponding respectively to the combinations specified by the intensity level represented by the higher order m bits of Y signal, the intensity level represented by the higher order n bits of U signal and the intensity level represented by the higher order n bits of V signal, of the input 1-bit Y, U and V signals, and add those respectively to the corresponding Y, U and V signals wherein, at the 2D-LUT 130, ignored are the intensity level represented by a (1-n)-bit U signal and the intensity level represented by a (1-n)-bit V signal. However, it should be understood that this is not limited. For example, an interpolation circuit may be provided between the 2D-LUT 130 and the addition circuits 141-143 so that the correcting value in accordance with the intensity level represented by a (1-N)-bit U signal and the intensity level represented by a (1-N)-bit V signal can be interpolated based on a correcting value determined from the 2D-LUT 130.

Meanwhile, this is true in the 2D-LUT 130a, 130b of the modification.

The 2D-LUT 130 of the exemplary embodiment and the 2D-LUT 130a, 130b of the modification are configured to store the correcting values corresponding, respectively, to the combinations in (2ⁿ×2ⁿ) patterns specified by the intensity levels represented by the higher order n bits of U signal and the intensity levels represented by the higher order n bits of V signal of among the combinations in (2¹×2¹) patterns specified by 1-bit U signal intensity levels and 1-bit V signal intensity levels. However, those may be configured to store the correcting values corresponding respectively to the combinations in (2¹×2¹) patterns specified by 1-bit U-signal intensity levels and 1-bit V-signal intensity levels.

Although the above exemplary embodiment and modification explained on the example that the YUV conversion circuit section 110 is to convert 1-bit R, G and B signals into the same bits of Y, U and V signals, conversion may be into different bits of Y, U and V signals from those of the R, G and B signals. Meanwhile, conversion may be into different bits of Y, U and V signals different one from another.

Meanwhile, the above exemplary embodiment and modification is to input the U and V signals at their higher order n bits to the 2D-LUT 130. However, the number of bits may be different from each other. The correcting values dy, du, dv to be outputted from the 2D-LUT 130 may be different in the number of bits instead of equal in the number of bits.

Furthermore, although the above exemplary embodiment and modification explained on the example that the color correction circuit section 120 is to output 1-bit Y, U and V signals while the RGB-conversion circuit section 150 is to convert 1-bit Y, U and V signals into 1-bit R, G and B signals, this is not limitative. The color correction circuit section 120 may output Y, U and V signals different in the number of bits one from another while the RGB-conversion circuit section 150 may convert the Y, U and V signals mutually different in the number of bits into the R, G and B signals same in the number of bits.

Meanwhile, although the above exemplary embodiment explained on the example that the RGB-conversion circuit section 150 is to convert 1-bit Y, U and V signals into 1-bit R, G and B signals, conversion may be into the R, G and B signals in the different number of bits from the number of bits of the Y, U and V signals.

In brief, the number of bits may be in any configuration for each signal.

Although the above exemplary embodiment and modification explained on the example to input an image signal represented by Y, U and V signals to the color correction circuit section, this is not limitative. Application is possible to the case where to input, to the color correction circuit section, various image signals represented by a light intensity signal and two chrominance signals same in kind as Y, U and V signals, e.g., Y, Cb, Cr signals or Y, Pb, Pr signals. Meanwhile, application is possible where to input, to the color correction circuit section, an image signal represented by a light intensity signal, a chroma signal and a hue signal.

Although the above exemplary embodiment exemplified the liquid-crystal projector to which the color correction circuit of the invention is applied, this is not limitative. Application is possible to various image display apparatuses.

While this invention has been described in conjunction with specific embodiments thereof, it is evident that many alternatives, modifications and variations will be apparent to those skilled in the art. Accordingly, preferred embodiments of the invention as set forth herein are intended to be illustrative, not limiting. There are changes that may be made without departing from the spirit and scope of the invention.

1. A color correction circuit that corrects for color of an image to be displayed in an image display apparatus, the color correction circuit comprising:
a two-dimensional lookup table;
a color correction circuit section that corrects for intensity level of at least one signal of three signals of a light-intensity signal, a first chrominance signal and a second chrominance signal that are inputted as an image signal representative of the image, by use of a correcting value stored in a two-dimensional lookup table, according to a combination in intensity level of the first and second chrominance signals; and
the two-dimensional lookup table storing as the correcting value, correcting values corresponding respectively to combinations to be specified by an intensity level of the first chrominance signal and an intensity level of the second chrominance signal.

2. A color correction circuit according to claim 1,
the two-dimensional lookup table storing, as the correcting value, an intensity-level signal correcting value, a first chrominance signal correcting value and a second chrominance signal correcting value that correspond, respectively, to the intensity-level signal, the first chrominance signal and the second chrominance signal.

3. A color correction circuit according to claim 2,
the intensity-level signal correcting value, the first chrominance signal correcting value and the second chrominance signal correcting value being a light-intensity signal offset value, a first chrominance signal offset value and a second chrominance signal offset value that are to be respectively added to the intensity-level signal, the first chrominance signal and the second chrominance signal; and
the color correction circuit section having three addition circuits that add the light-intensity signal offset value, the first chrominance signal offset value and the second chrominance signal offset value, respectively, to corresponding ones of the intensity-level signal, the first chrominance signal and the second chrominance signal.

4. A color correction circuit according to claim 1,
the two-dimensional lookup table storing, as the correcting value, a first chrominance signal correcting value and a second chrominance signal correcting value that correspond, respectively, to the first chrominance signal and the second chrominance signal.

5. A color correction circuit according to claim 1,
the first chrominance signal correcting value and the second chrominance signal correcting value being a first chrominance signal offset value and a second chrominance signal offset value that are to be respectively added to the first chrominance signal and the second chrominance signal; and
the color correction circuit section having two addition circuits that add the first chrominance signal offset value and the second chrominance offset value, respectively, to corresponding ones of the first chrominance signal and the second chrominance signal.

6. A color correction circuit according to claim 1,
the two-dimensional lookup table stores, as the correcting value, a light-intensity signal correcting value corresponding to the light-intensity signal.

7. A color correction circuit according to claim 6,
the intensity-level signal correcting value being a light-intensity signal offset value to be added to the intensity-level signal; and
the color correction circuit section adding the intensity-level signal offset value to a corresponding one of the intensity-level signal.

8. A color correction circuit according to claim 1, comprising:
a first color converting circuit section that converts the light-intensity signal, the first chrominance signal and the second chrominance signal that are outputted from the color correction circuit section into a red signal corresponding to red, a green signal corresponding to green and a blue signal corresponding to blue.

9. A color correction circuit according to claim 8, further comprising;
a second color converting circuit section that converts a red signal, a green signal and a blue signal that are inputted as an image signal representative of the image into the light-intensity signal, the first chrominance signal and the second chrominance signal that are to be inputted to the color correction circuit section.

10. An image display apparatus, comprising:
a color correction circuit according to claim 1.
